(19) United States
(12) Patent Application Publication
(10) Pub. No.: US 2002/0101625 A1
(43) Pub. Date: Aug. 1, 2002

(54) Image reading apparatus and method for cleaning in image reading apparatus

(75) Inventor: Naoki Shouji, Kanagawa-ken (JP)

Correspondence Address: FOLEY & LARDNER, Washington Harbour, 3000 K Street, N.W., Suite 500, P.O. Box 25696, Washington, DC, 20007-8696, US

(73) Assignee: TOSHIBA TEC KABUSHIKI KAISHA

(21) Appl. No.: 09/750,045

(22) Filed: Dec. 29, 2000

(51) Int. Cl. H04N 1/04

(52) U.S. Cl. 358/474

(57) ABSTRACT

The image reading device of the invention has an image reading for reading original images from original documents sequentially conveyed onto a contact glass, a reading roller which is positioned to face the contact glass and sequentially conveys the original documents onto the contact glass, and a cleaning brush which is fitted to the reading roller and protruded from the reading roller in association with the rotations of the reading roller to clean the image reading position in sliding contact with it, and removes foreign substances adhered to a contact glass by the cleaning brush while rotating the reading roller in order to convey the original documents onto the contact glass. And, the image-reading device of the invention also has a foreign substance accumulation unit for accumulating the removed foreign substances in it.

### BACKGROUND OF THE INVENTION

1. Field of the Invention

The invention relates to a through read image reading device for sequentially reading original documents which are passing along the surface of a contact glass, and more particularly to an image reading device which removes a foreign substance adhered to the contact glass surface and a cleaning method of the image reading device.

2. Description of the Related Art

When an image scanner, a digital copy machine or the like reads original documents, which are sequentially passed along the contact glass surface by a through-read type automatic original feeder, by means of a stationary image sensor, a foreign substance such as paper dust or other dust adhered to the contact glass surface is read as a black stripe on the read image, and the read image is degraded. As a result, when the read image is reproduced, a black stripe is produced on the formed image, and the display quality is considerably degraded.

In order to prevent the occurrence of such a black stripe due to a foreign substance adhered to the contact glass, a serviceman at regular maintenance conventionally cleaned the contact glass manually. But, because the adhered state of the foreign substance is variable depending on the frequency of use, the material of original documents or the like, the user had to manually clean the contact glass when it was contaminated, and the operation of image reading by the user was hindered.

Accordingly, there have been proposed technologies such as Japanese Patent Application Laid-Open Publication No. 1124184 which moves a paper-like cleaning member along the contact glass after terminating the image reading to automatically clean the contact glass surface and Japanese Patent Application Laid-Open Publication No. 11-46288 which removes a foreign substance by electrically charging a backup roller, which is one of original conveying means and opposed to the contact glass, to adsorb the foreign substance from the contact glass surface by a Coulomb force and keep it on the backup roller for removal.

But, the former reference, which moves a paper-like cleaning member to the contact glass position, must be provided with accommodation and conveying means in order to accommodate the cleaning member, to move it from the accommodation position to the contact glass and to retract it into the accommodation position. Besides, the cleaning operation by the cleaning member must be performed after completing the image reading operation. The latter reference, which removes a foreign substance by electrically charging the backup roller to adsorb the foreign substance to remove it, must have auxiliary conveying means separately because the original document is also adsorbed by the backup roller and cannot be conveyed by the backup roller alone.

Therefore, the through read type image reading device is desired to clean the contact glass automatically and substantially simultaneously when the reading roller conveys the original document to the contact glass without requiring conveying means for conveying the cleaning member or auxiliary conveying means for conveying the original documents.

### SUMMARY OF THE INVENTION

It is an object of the invention to obtain good image information by securely removing a foreign substance adhered to the surface of a contact glass without a wiping work by a user to keep a read image of good quality.

It is also an object of the invention to remove a foreign substance automatically when the original document is conveyed without requiring an additional conveying device or the like for removing the foreign substance adhered to the surface of a contact glass.

It is also an object of the invention to prevent the foreign substance removed from the contact glass surface from adhering again to peripheral equipment.

The present invention provides an image reading device, which comprises an image sensor configured to read original images of original documents being conveyed sequentially to an image reading position; a conveying roller located to oppose the image reading position to convey the original documents sequentially to the image reading position; and a cleaner fitted to the conveying roller and protruded from the conveying roller by rotation of the conveying roller to clean the image reading position in sliding contact with the image reading position.

The invention also provides an image reading device, which comprises a CCD scanner configured to read original images from original documents sequentially conveyed to a contact glass; a reading roller positioned to oppose the contact glass to sequentially conveys the original documents to the contact glass; and a cleaning brush fitted to the reading roller and protruded from the reading roller by rotation of the reading roller to clean the image reading position in sliding contact with the image reading position.

The invention also provides a cleaning method in an image reading device comprising the steps of protruding a cleaning brush, which is fitted to a reading roller, from the surface of the reading roller by the rotation of the reading roller; and cleaning an image reading potion in sliding contact with the image reading position by the cleaning brush protruded from the surface of the reading roller.

### BRIEF DESCRIPTION OF THE DRAWINGS

FIG. 1 is an explanatory diagram schematically showing a scanner according to a first embodiment of the invention;

FIG. 2 is an explanatory diagram showing accumulation of foreign substances to a foreign substance accumulation section of the first embodiment of the invention;

FIG. 3 is an explanatory diagram showing a reading roller of the first embodiment of the invention;

FIG. 4 is an explanatory diagram schematically showing a part of the automatic original feeding device of a second embodiment of the invention; and

FIG. 5 is an explanatory diagram showing a reading roller of the second embodiment of the invention.

### DETAILED DESCRIPTION OF THE PREFERRED EMBODIMENTS

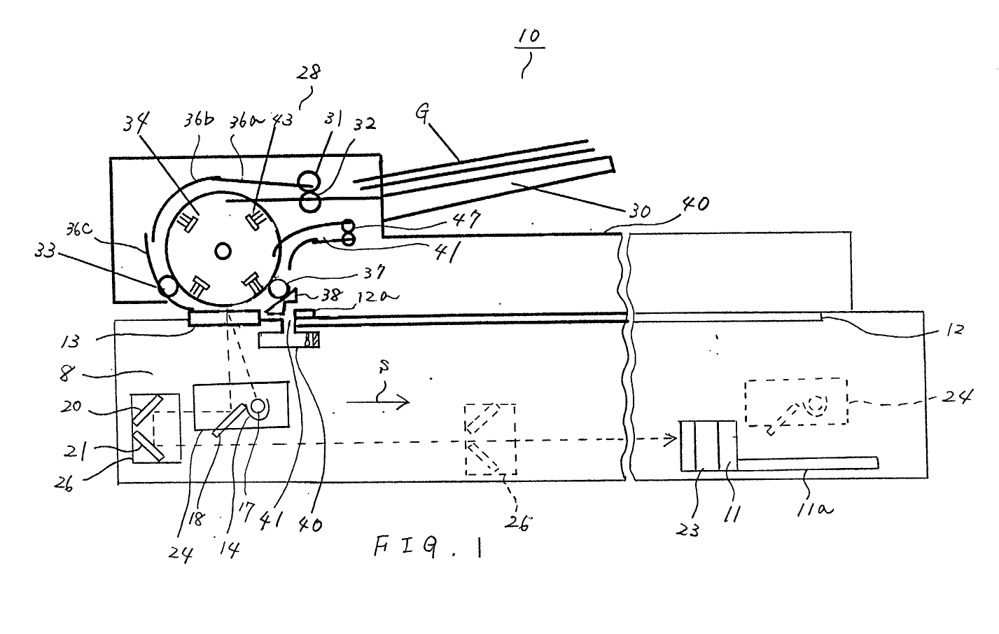

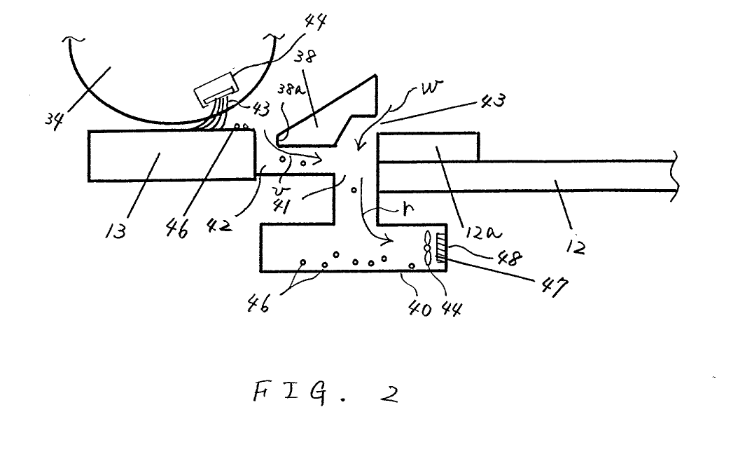

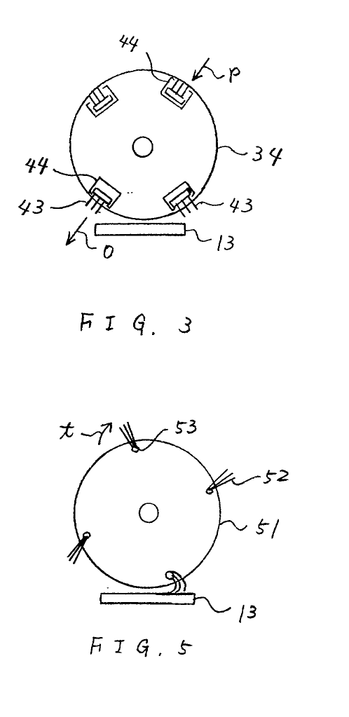

Preferred embodiments of the invention will be described in detail with reference to the accompanying drawings. FIG. 1 schematically shows the image-reading device of a first embodiment of the invention, which is a scanner 10 having a CCD sensor 11 as a part of an image sensor. A document base 12 made of a transparent glass plate and having a positioning plate 12a at one end is disposed above the CCD sensor 11 having a control circuit board 11a, and a contact glass 13 is disposed at an image reading position where original documents G are sequentially conveyed by an automatic original feeding device 28 located forward of the document base 12.

A suction port 41 of a foreign substance accumulation unit 40 for accumulating foreign substances removed from the surface of the contact glass 13 is formed between the document base 12 and the contact glass 13. An image reflected light from the original document G positioned on the document base 12 or the original document G passing through the contact glass 13 is projected to the CCD sensor 11 by an optical system 8 which consists of a lamp 17 whose light is collected to a reflector 14, first to third mirrors 18, 20, 21 and a lens 23 and is a part of the image sensor.

The reflector 14, the lamp 17 and the first mirror 18 are mounted on a first carriage 24, and the second and third mirrors 20, 21 are mounted on a second carriage 26. The first carriage 24 and the second carriage 26 are generally positioned in home positions as indicated by the solid line in FIG. 1 and if necessary slid along a rail (not shown) as indicated by the dotted line in FIG. 1 when the image of the original document placed on the document base is read.

The through read type automatic original feeding device 28 for automatically feeding the original document G onto the contact glass 13 is disposed above the document base 12. The automatic original feeding device 28 has a paper feed roller 31 for feeding the original documents G from an original loading tray 30 and a separation roller 32 which is in contact with the paper feed roller 31, a reading roller 34 which sandwiches the original document G supplied by the paper feed roller 31 with an aligning roller 33 to convey to the contact glass 13, and guide plates 36a, 36b, 36c for guiding the original document G along the reading roller 34.

The automatic original feeding device 28 also has a transmission roller 37 which sandwiches the original document G having passed along the contact glass 13 with the reading roller 34 to convey it in a paper discharging direction, and a jumping stand 38 for guiding the original G to the transmission roller 37, and also has a paper discharge guide 41 and a paper discharge roller 42 for discharging the original G to the original discharge tray 40.

The reading roller 34 includes four cleaning brushes 43 which are made of a nylon brush or the like and can be protrudable from the surface of the reading roller 34 under their own weights. Specifically, the each cleaning brush 43 is housed in slits 44 formed within the reading roller 34 so to be freely slidable under its own weight in a radial direction of the reading roller 34 along a rail (not shown).

Thus, the each cleaning brush 43 reaches the lower end as the reading roller 34 rotates, slides under its own weight outward in a direction as indicated by an arrow o within the slit 44 and protrudes its end from the surface of the reading roller 34. When the cleaning brush 43 is protruded from the reading roller 34, it slides in contact with the contact glass 13 if no original G is on the contact glass 13. Besides, the cleaning brush 43 reaches the top as the reading roller 34 rotates, slides inward under its own weight within the slit 44 as indicated by an arrow p and is housed within the reading roller 34.

The foreign substance accumulation unit 40 is disposed between the document base 12 and the CCD sensor 11, and the jumping stand 38 is disposed above the suction port 41 formed between the document base 12 and the contact glass 13 so to provide first and second suction passages 42, 43. The jumping stand 38 has its end 38a on the side of the contact glass 13 formed to be lower than the surface of the contact glass 13 so that the end of the original G has passed along the contact glass 13 is not caught.

The foreign substance accumulation unit 40 has therein a suction fan 44 that produces a current of air in a direction indicated by an arrow r from the suction port 41 to an exhaust port 48. Thus, a current of air is produced as indicated by arrows v, w in the suction passages 42, 43 near the suction port 41. A filter 47 is attached to the exhaust port 48 in order to prevent the accumulated foreign substances 46 from being discharged.

Then, an operation will be described. To read the originals G by conveying them onto the contact glass 13 by the automatic original feeding device 28, the originals G are placed on the original loading tray 30, and a print key (not shown) is turned on to start the reading operation.

When the reading operation is started, the paper feed roller 31 and the separation roller 32 are driven to take the top original G from the original loading tray 30 to feed it to the position of an aligning roller 33 along the guide plates 36a, 36b, 36c. The original G is adjusted its end by the aligning roller 33, caught between the aligning roller 33 and the reading roller 34 and conveyed to the position of the contact glass 13.

At this time, the first and second carriages 24, 26 are located at the home positions below the contact glass 13 as indicated by the solid line in FIG. 1. While the originals G are sequentially conveyed by the aligning roller 33 and the reading roller 34 and passed along the contact glass 13, the optical system irradiates the originals G by the lamp 17 through the contact glass 13, reflected light from the original G by the irradiation sequentially forms images at the CCD sensor 11 through the first to third mirrors 18, 20, 21 and the lens 23, and image information of the originals G are stored in a storage device (not shown) to read the original images.

Then, the original G having passed along the contact glass 13 is guided by the jumping stand 38 to between the reading roller 34 and the transmission roller 34, guided by the paper discharge guide 41, discharged onto the original discharge tray 40 by the paper discharge roller 42, and the image reading is terminated.

And, when the foreign substances such as paper dust and other dust drop onto the contact glass 13 while the original G is passing along the contact glass 13, they are partly removed from the surface of the contact glass 13 owing to the sliding contact of the original G, but the foreign substances 46 adhered to the surface of the contact glass 13 are removed by the cleaning brushes 43 during the image reading operation. Specifically, the reading roller 34 is rotated when the image reading operation is started, the cleaning brushes 43 housed in the slits 44 of the reading roller 34 approach the contact glass 13 and slide under their own weights in the direction of the arrow o within the slits 44, so that their ends are protruded from the surface of the reading roller 34.

When the original G is passing along the surface of the contact glass 13, the cleaning brushes 43 are restricted their protrusion from the surface of the reading roller 34 by the original G. On the other hand, if there is not any original G, the ends of the cleaning brushes 43 are slid in contact with the surface of the contact glass 13, and if any foreign substance such as paper dust or the like is adhered to the contact glass 13, it is swept in the direction of the suction passage 42 by means of the elasticity of the brushes 43.

Then, the reading roller 34 rotates further, and the cleaning brush 43 leaves from the contact glass 13 and slides under its own weight in the direction of the arrow p within the slit 44 and is housed within the reading roller 34. Thus, when the reading operation is being performed, the contact glass 13 is sequentially in sliding contact with the four cleaning brushes 43 in the reading roller 34 and has the foreign substances 46 adhered thereto removed.

At this time, the foreign substance accumulation unit 40 produces a current of air in the direction of the arrow r by driving the suction fan 44 and also produces currents of air in the directions of arrows v, w in the suction passages 42, 43, so that the foreign substances 46 swept out by the cleaning brushes 43 are accumulated in the foreign substance accumulation unit 40 from the suction port 41 through the suction passage 42 by the current of air. If the foreign substances 46 are dispersed over the jumping stand 38 in the direction of the document base 12, they are accumulated in the foreign substance accumulation unit 40 through the suction port a 41 via the suction passage 43 by the current of air in the direction of the arrow w.

Then, where the operator to read an image manually supplies the original G onto the document base 12, the automatic original feeding device 28 is opened, the original G is placed on the document base 12, and the print key is turned on to start the reading operation. At this time, the first and second carriages 24, 26 are slid from the home position to below the document base 12 so to read the original G placed on the document base 12 and further slid in the direction of the arrow s as indicated by the dotted line in FIG. 1 so to scan the original G.

During the above operation, the reflection light from the original G by the lamp 17 forms images at the CCD sensor 11 through the first to third mirrors 18, 20, 21 and the lens 23, and the image information of the original G is stored in the storage device (not shown) to read the original. And, after the original G is read, the first and second carriages 24, 26 are returned to the home positions, and the reading operation is terminated.

By configuring as described above, the user does not need to manually clean the contact glass 13, and the cleaning brushes 43 can be protruded from the surface of the reading roller 34 by the rotations of the reading roller 34 when the original G is read by the automatic original feeding device 28 so to slide in contact with the surface of the contact glass 13 and the adhered foreign substances 46 can be removed. Therefore, the read information is free from any black stripe resulting from the foreign substances 46 adhered to the contact glass, and good image information can be obtained.

Besides, the cleaning brushes 43 automatically slide under their own weights within the slits 44 of the reading roller 34, so that an additional drive or the like is not necessary to slide the cleaning brushes 43 to make the foreign substance removing operation. And, when the reading roller 34 is conveying the original G, the cleaning brushes 43 are restricted their protrusion from the surface of the reading roller 34 regardless of their own weights, and the original G is not prevented from being conveyed.

Furthermore, the foreign substances 46 removed from the surface of the contact glass 13 can be sucked and accumulated into the foreign substance accumulation unit 40 which is disposed next to the contact glass 13, so that the foreign substances 46 removed from the surface of the contact glass 13 can be prevented from adhering again to the contact glass 13 or the periphery of the document base 12.

Then, a second embodiment of the invention will be described. The second embodiment is the same as the first embodiment except that the cleaning brushes mounted on the reading device of the first embodiment have a different structure. Therefore, the second embodiment uses like reference numerals for like components of those used in the first embodiment, and their detailed descriptions will be omitted.

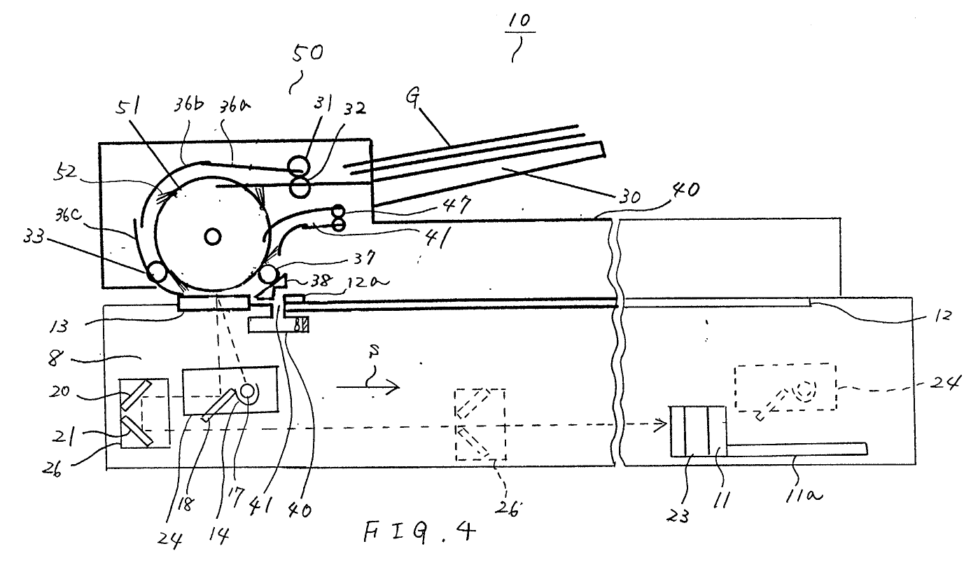

Four cleaning brushes 52 are housed in the direction of a tangent to a reading roller 51 used for an automatic original feeding device 50 of the second embodiment. The cleaning brushes 52 can be turned by 90 degrees in a radial direction by the centrifugal force caused as the reading roller 51 rotates. Specifically, when the reading roller 51 is not rotating, the cleaning brushes 52 are retracted in a direction of the tangent to the surface of the reading roller 51 as shown in FIG. 4 by a coil spring (not shown) which operates on a fitting axis 53 of the each cleaning brush 52.

And, because the reading rotor 51 is rotated when the automatic original feeding device 50 is driven, the cleaning brush 52 is turned in the direction of an arrow t by the centrifugal force against the coil spring to protrude from the surface of the reading roller 51 as shown in FIG. 5. At this time, if no original G is on the contact glass 13, the cleaning brush 52 slides in contact with the contact glass 13. When the reading roller 51 is stopped after the original G is read, the cleaning brush 52 is turned by the coil spring in an opposite direction to the direction of the arrow t so that it is housed in the direction of a tangent to the reading roller 51.

Then, an operation will be described. When the operation of reading the originals G by the automatic original feeding device 50 is started, the originals G are fed by the paper feed roller 31 and the separation roller 32 and have their ends aligned by the aligning roller 33. The originals G are held between the aligning roller 33 and the reading roller 51 and conveyed onto the contact glass 13. When the originals G are sequentially passing along the contact glass 13, the optical system directs the reflection light from the originals G by the lamp 17 to sequentially form an image at the CCD sensor 11 to store image information of the originals G into a storage device (not shown). Then, the originals G has passed along the contact glass 13 are discharged onto the original discharge tray 40, and the image reading is terminated.

During the above operation, the cleaning brushes 52 remove the foreign substances 46 adhered to the contact glass 13. Specifically, when the reading roller 51 rotates, the cleaning brushes 52 are turned in the direction of the arrow t to protrude from the surface of the reading roller 51 by the centrifugal force caused by the rotation of the reading roller 51.

And, when no original G is on the contact glass 13, the cleaning brushes 52 slide in contact with the surface of the contact glass 13 to sweep out the foreign substances 46 such as paper dust and the like in the direction of the suction passage 42 by the elasticity of the brushes. But, when the original G is passing along the contact glass 13, the cleaning brush 52 is suppressed its turn toward the outside of the surface of the reading roller 51 by the original G regardless of the centrifugal force of the reading roller 51. Then, when the reading roller 51 stops its rotation, the cleaning brushes 52 are housed in the direction of the tangent to the reading roller 51 by the pulling force of the coil spring (not shown).

Then, the foreign substances 46 removed from the surface of the contact glass 13 are accumulated into the foreign substance accumulation unit 40 from the suction port 41 through the suction passage 42 or the suction passage 43 over the jumping stand 38 by the currents of air at the foreign accumulation unit 40 and its periphery.

By configuring as described above, the user does not need to manually clean in the same way as in the first embodiment, the cleaning brushes 52 can be protruded automatically from the surface of the reading roller 51 by the centrifugal force by the rotations of the reading roller 51 when the original G is conveyed to the contact glass 13 in the automatic original feeding device 50, so that the ends of the protruded cleaning brushes 52 can slide in contact with the surface of the contact glass 13 to remove the adhered foreign substances 46. Therefore, the read information is free from any black stripe resulting from the foreign substances 46 adhered to the contact glass 13, and good image information can be obtained. Besides, an additional drive or the like for removing the foreign substances is not required. Furthermore, the foreign substances 46 removed from the surface of the contact glass can be accumulated into the foreign substance accumulation unit 40 and prevented from adhering again to the periphery.

The invention is not limited to the above embodiment and can be modified in various ways within the scope of the invention. For example, the cleaning brush may be made of soft fiber as long as it can remove the foreign substances adhered to the surface of the contact glass by the slidable contact without damaging the contact glass. But, the nylon brush having elasticity used in the above embodiments can achieve an effect of sweeping out by elasticity achieved, and the foreign substances are readily accumulated into the foreign substance accumulation unit.

The number of cleaning brushes attached to the reading roller is arbitrary, and the image reading device may be a device which is not provided with a document base for reading a stationary original but has only a through read type reading function for reading the originals conveyed by the automatic original feeding device. Besides, the structure of the foreign substance accumulation unit is also arbitrary, and a suction fan may be disposed on the rear side of the image-reading device to produce a current of air so to discharge the air from the suction port to the rear side of the body.

As described above in detail, the through read type image reading device according to the invention can remove the foreign substances adhered to the surface of the contact glass by the sliding contact of the cleaning brushes attached to the reading roller with the surface of the contact glass while the reading roller rotates in the image reading operation. Therefore, a black stripe can be prevented from being produced by the foreign substances adhered to the contact glass, a high-quality read image can be obtained readily, and reliability can be improved.

Besides, a conventional cleaning work by the user can be eliminated. And, the operation can be made to clean by the cleaning brushes as the reading roller rotates, so that an additional drive for operating the cleaning brushes is not required. Besides, the foreign substances removed from the surface of the contact glass by the cleaning brushes are accumulated into the foreign substance accumulation unit, so that the foreign substances can be prevented from adhering again to the peripheral equipment and the acquisition of a high quality image can be assured.

What is claimed is:

1. An image reading device, comprising:
an image sensor configured to read original images of original documents being conveyed sequentially to an image reading position;
a conveying roller located to oppose the image reading position to convey the original documents sequentially to the image reading position; and
a cleaner fitted to the conveying roller and protruded from the conveying roller by rotation of the conveying roller to clean the image reading position in sliding contact with the image reading position.

2. The image reading device according to claim 1, further comprising a vessel configured to accumulate foreign substances removed from the image reading position by the cleaner.

3. The image reading device according to claim 1, wherein the cleaner is a brush which is retractable into the conveying roller and protrudes under its own weight from the surface of the conveying roller at a position to face the image reading position.

4. The image reading device according to claim 1, wherein the cleaner is a brush which is retractable into the conveying roller and protruded from the surface of the conveying roller by the centrifugal force occurred by the rotation of the conveying roller.

5. The image reading device according to claim 2, wherein the cleaner is a brush which is retractable into the conveying roller and protrudes from the surface of the conveying roller under its own weight at a position to face the image reading position.

6. The image reading device according to claim 2, wherein the cleaner is a brush which is retractable into the conveying roller and protruded from the surface of the conveying roller by the centrifugal force occurred by the operation of the conveying roller.

7. An image reading device, comprising:
a CCD scanner configured to read original images from original documents sequentially conveyed to a contact glass;
a reading roller positioned to oppose the contact glass to sequentially conveys the original documents to the contact glass; and
a cleaning brush fitted to the reading roller and protruded from the reading roller by rotation of the reading roller to clean the image reading position in sliding contact with the image reading position.

8. The image reading device according to claim 7, further comprising a foreign substance accumulation section configured to accumulate foreign substances removed from the contact glass by the cleaning brush.

9. The image reading device according to claim 7, wherein the cleaning brush is retractable into the reading roller and protrudes from the surface of the reading roller under its own weight at a position to face the contact glass.

10. The image reading device according to claim 7, wherein the cleaning brush is retractable into the reading roller and protruded from the surface of the reading roller by the centrifugal force occurred by the rotations of the reading roller.

11. The image reading device according to claim 8, wherein the cleaning brush is retractable into the reading roller and protruded from the surface of the reading roller under its own weight at a position to face the contact glass.

12. The image reading device according to claim 8, wherein the cleaning brush is retractable into the reading roller and protruded from the surface of the reading roller by the centrifugal force occurred by the rotations of the reading roller.

13. A cleaning method in an image reading device comprising the steps of:
protruding a cleaning brush, which is fitted to a reading roller, from the surface of the reading roller by the rotation of the reading roller; and
cleaning an image-reading potion in sliding contact with the image reading position by the cleaning brush protruded from the surface of the reading roller.

14. The cleaning method according to claim 13 further comprising the step of accumulating foreign substances, which are removed from the reading position by the sliding contact cleaning by the cleaning brush, into a foreign substance accumulation unit.

15. The cleaning method according to claim 13, wherein the cleaning brush is protruded from the surface of the reading roller under its own weight.

16. The cleaning method according to claim 13, wherein the cleaning brush is protruded from the surface of the reading roller by the centrifugal force occurred by rotation of the reading roller.

17. The cleaning method according to claim 14, wherein the cleaning brush is protruded from the surface of the reading roller under its own weight.

18. The cleaning method according to claim 14, wherein the cleaning brush is protruded from the surface of the reading roller by the centrifugal force occurred by rotation of the reading roller.
